(19) United States
(12) Patent Application Publication
(10) Pub. No.: US 2012/0133498 A1
(43) Pub. Date: May 31, 2012

(54) TIRE INFORMATION MONITORING APPARATUS

(75) Inventors: Seung Wook Nah, Yongin-shi (KR); Toshiaki Watanabe, Owariasahi-shi (JP); Junya Muramatsu, Aichi-gun (JP); Nobuhiro Ide, Toyota-shi (JP)

(73) Assignee: TOYOTA JIDOSHA KABUSHIKI KAISHA, Toyota-shi, Aichi-ken (JP)

(21) Appl. No.: 13/255,824

(22) PCT Filed: Apr. 6, 2010
(86) PCT No.: PCT/IB2010/000752

§ 371 Date: Sep. 9, 2011

(30) Foreign Application Priority Data
Apr. 8, 2009 (JP) 2009-094381

(51) Int. Cl. B60C 23/02

(52) U.S. Cl. 340/447

(57) ABSTRACT

The changing of the azimuth of directivity in which the azimuth of directivity of the antenna that achieves the maximum gain thereof is switched to the azimuths of tires is performed repeatedly for a plurality of cycles during a transmission duration of information. The output value of the antenna whose azimuth of directivity is controlled is sampled separately for each of the azimuths of directivity subjected to the switching. The sampled values are sorted into groups separately for each azimuth of directivity, and are accumulated separately for each group. The position of the tire shown by the azimuth of directivity of the group whose accumulated value is the largest is determined as being the position of the tire equipped with the transmitter that is transmitting the information.

### BACKGROUND OF THE INVENTION

1. Field of the Invention

The invention relates to a tire information monitoring apparatus which transmits tire information regarding the air pressure, the temperature, etc., of tires of a vehicle, from transmitters that are disposed at the tires, and which receives the information by an antenna that is provided on a ceiling of a middle portion of the vehicle and that is capable of switching the directivity (main beam). In particular, the invention relates to an apparatus capable of identifying a tire that is sending out tire information, without depending on the ID information of the tire.

2. Description of the Related Art

A known apparatus for monitoring the air pressure of tires of a vehicle is an apparatus that always monitors the air pressure of tires of a vehicle by detecting the air pressure of each tire by a corresponding one of pressure sensors provided for the tires, and transmitting the data about the detected air pressure of each tire from a corresponding one of transmitters provided for the tires, and receiving the data about the tire air pressure by an antenna that is disposed on a ceiling of a cabin of the vehicle. In this apparatus, it is determined which one of the tires the received air pressure data is from, on the basis of the unique ID of each tire that is included in the received data. However, if the positions of the tires in the vehicle are changed, the correspondence between the tire positions and the tire IDs cannot be obtained, and therefore it cannot be determined which one of the tires mounted at the predetermined positions the received air pressure data is from. Therefore, every time the positions of the tires are changed, the tire air pressure monitoring apparatus needs to update the table of correspondence between the positions of the tires and the IDs of the tires. Therefore, this table updating is difficult in the case where the owner of a vehicle him/herself changes the positions of the tires.

Therefore, in order to solve this problem, there exists a known technology disclosed in International Publication WO2006/038557. This technology of International Publication WO2006/038557 determines the information received by switching the azimuth of directivity to the positions of tires, as the information transmitted from the tire that is positioned in the azimuth of directivity. Besides, there is another disclosed technology in which a data request signal is output from a transmitting antenna while directing the directivity of the antenna to each of the azimuths of the position of the tires, and only the transmitter of a tire that receives the signal responds to transmit the data about the air pressure of the tire. Since the data request signal is transmitted by directing the directivity of the antenna in the azimuth of the position of each tire, it can be determined which one of the tires has transmitted the received data.

Besides, Japanese Patent Application Publication No. 2007-320410 (JP-A-2007-320410) discloses a technology in which the directivity of a receiving antenna is switched to the azimuths of the positions of tires, and a correspondence relation between the ID of each tire included in the data transmitted from the tire and the directivity of the antenna is stored. Due to this technology, if the positions of the tires are changed, the table of correspondence is subjected to the updating of the azimuths of the positions of the tires and the tire IDs to the latest data. Therefore, after that, it can be determined which one of the tires the received air pressure data is from on the basis of the ID that is included in the received data.

According to the methods described in International Publication WO2006/038557 and Japanese Patent Application Publication No. 2007-320410 (JP-A-2007-320410) mentioned above, data is received while the directivity of a receiving antenna is changed, and the tire that has sent out the received data is specifically determined on the basis of the directivity of the receiving antenna. Therefore, if the positions of the tires are changed, the relation between the tire IDs and the positions of the tires is updated, so that the tire that has transmitted the tire air pressure data can be specifically determined.

However, the transmitter provided for each tire is disposed on a circumferential portion of the tire that rotates. For example, since the transmitter is disposed near a pressurized air intake valve of a circular tire, the transmitter may sometimes be hidden from the receiving antenna, or relation of polarization may become orthogonal, depending on the rotational position of the tire. As a result, the level of a received signal greatly fluctuates in association with the rotational position of the tire.

Therefore, even if the directivity of the receiving antenna is directed in the azimuth of the tire that is transmitting data and the data is thus received, the signal level obtained in a first case where the signal is received when the propagation environment of the transmitter and the receiving antenna is optimum and the signal level obtained in a second case where the data is received when the propagation environment is the worse differ greatly from each other.

On the other hand, the received signal level, in the case where transmission data is received during the state in which the directivity is not directed in the azimuth of the tire, is lower than the signal level obtained in the first case, but is sometimes higher than the reception level obtained in the second case. In the foregoing method, in the case where the present azimuth of directivity of the antenna which is different from the azimuth of the tire that is actually transmitting data, the azimuth of directivity, which gives a greater reception level, is sometimes falsely determined as being the azimuth of the tire that is transmitting the data.

Concretely, the transmitter attached to a tire air pressure sensor is required to be very small in size, and therefore the level of the transmission signal is very low. Furthermore, since the locations at which the transmitters are attached are limited as described above, the level fluctuation of the received signal relative to the rotation angle of the tires is large. Generally, the level fluctuation width of the received signal is at least 10 dB regardless of what frequency is used. Specifically, in the case where the azimuth of the directivity (of a main beam) is simply directed to the azimuth of the position of a tire and the azimuth is specifically determined on the basis of only the presence/absence of a received signal or the magnitude relation among the levels of received signals, the ratio between the level of the signal received from the azimuth in which the directivity is directed, and the level of the signal received from an azimuth that is different from the foregoing azimuth of directivity needs to be at least 10 dB.

However, of the frequencies (315 MHz, 433 MHz, 125 MHz, and 2.5 GHz) that are permitted for weak wireless electromagnetic wave systems, such as a tire information monitoring apparatus, at frequencies other than the 2.5 GHz band, it is impossible to meet the foregoing characteristic requirements while maintaining size reduction. Besides, in the case where a directivity beam whose D/U ratio is large is used in order to specifically determine azimuth, if the directivity is directed in a specific azimuth, the transmission data from a transmitter disposed in an azimuth in which the directivity is not directed cannot be received. Specifically, synchronization between the directivity and the transmission timing becomes necessary, and data cannot be transmitted until the directivity of the antenna is directed to the transmitter. The communication timing being specifically determined poses great problem in practice in the wireless system that performs intermittent transmission. On the other hand, in the case where the D/U ratio is made small so that receiving a reception signal from an azimuth in which the directivity of the antenna is not directed to always monitor the tire air pressure, the levels of reception signals from the azimuths in which the directivity is not directed exist between the maximum level and the minimum level of the reception signal from the azimuth in which the directivity is directed. Therefore, the number of false determinations increases in the case where determination of azimuth is performed on the basis of the level of signal.

### SUMMARY OF THE INVENTION

The invention provides a tire information monitoring apparatus that prevents false determination regarding the identification of a tire that has sent reception data even when the tire is rotating in the case where the directivity of a receiving antenna has been changed to the azimuth of the mounted position of each tire.

A first aspect of the invention relates to a tire information monitoring apparatus that monitors state of each of tires of a vehicle by transmitting information detected about each of the tire intermittently from a corresponding one of transmitters that are provided individually for the tires, and receiving the information by an antenna that is attached to the vehicle. The tire information monitoring apparatus has: directivity control means for controlling an azimuth of directivity of the antenna so that changing of the azimuth of directivity, in which the azimuth of directivity that achieves a maximum gain of the antenna is switched to an azimuth of a position of each of the tire, is performed repeatedly for a plurality of cycles during a transmission duration of the information; sampling means for sampling a value received by the antenna that is controlled by the directivity control means, separately for each of the azimuths of directivity that is switched to the azimuth of the position of each of the tire; accumulation means for sorting the values sampled by the sampling means into groups separately for each of the azimuth of directivity that is switched to the azimuth of the position of each of the tire, and accumulating the values separately for each of the group; and azimuth determination means for determining the position of the tire shown by the azimuth of directivity of the group whose value accumulated by the accumulation means is the largest of the values of the groups accumulated by the accumulation means as being the position of the tire equipped with the transmitter that is transmitting the information.

As for the control of switching the azimuth of directivity of the antenna, there are a method of discretely changing the azimuth that achieves the maximum reception sensitivity, and a method in which the azimuth that achieves the maximum reception sensitivity is continuously changed and the received signal level is sampled when the azimuth of the antenna is directed to the position of any one of the tires. With regard to the latter method, the azimuth of directivity of the antenna is substantially discretely switched in the event. Therefore, the foregoing aspect of the invention includes this manner of the directivity switching control as well.

In the foregoing aspect of the invention, for example, in the case where the tires to be monitored exist in four azimuth from the viewpoint of the antenna, the level of the received signal is sampled when the azimuth of directivity of the antenna is directed to any one of the positions of the tires. Then, the sampled values are sorted into groups separately for each of the four azimuths, and the reception level of the sampled values are integrated over the transmission duration of a set of information (the duration of one, packet of data) separately for each group. Therefore, if it is assumed that the switching to the four azimuths of directivity is one cycle of the directivity switching control, the directivity switching control is performed for a plurality of cycles during the transmission duration of a piece of information. The greater the number of cycles of the control, the greater the number of the sampled data that belongs to each one of the azimuths of directivity, and therefore the azimuth determination accuracy correspondingly improves.

During the predetermined transmission duration of a set of information, even if the azimuth of directivity of the antenna is fixed to the azimuth of transmission of the information, the reception level fluctuates with rotation of the tire. Besides, in the cases where a signal is received by the antenna when the azimuth of directivity of the antenna does not coincide with the position of the tire that is transmitting the signal, the reception level also fluctuates with rotation of the tire.

The sets of sampled values obtained separately in each of the azimuths of directivity, when the tires are rotating, give traces of the time-dependent change characteristic curves of the reception level in the case where signals are received by the antenna when the azimuth of directivity thereof is fixed to each of the azimuths of directivity to the tires. With regard to the signal transmitted from a certain tire, the sets of sampled values obtained separately in each of the azimuths of directivity provide four time-dependent change characteristic curves of the reception level. If the four time-dependent change characteristic curves of the reception level during the transmission duration of a piece of information are compared, it can be seen that the time-dependent change characteristic curve of the reception level obtained when the signal is received in the azimuth of directivity that coincides with the position of the tire that is transmitting the signal extends at the highest positions among the four curves, regardless of whether the tire is rotating or not, or regardless of the angular position of the tire that is transmitting the signal. Then, the three time-dependent change characteristic curves of the reception level obtained in the other azimuths of directivity are positioned below the foregoing curve. The four time-dependent change characteristic curves of the reception level do not cross each other, but are parallel with each other.

The greater the number of cycles of the changing of the azimuth of directivity during the transmission duration of a piece of information, the greater the number of sampled values becomes, and therefore the more accurately the time-dependent change characteristic curve of the reception level can be traced. For these reasons, the accumulated value of the reception levels sampled separately in each of the azimuths of directivity gives an average value of the reception levels in the corresponding one of the azimuths of directivity. Then, since the four time-dependent change characteristic curves of the reception level are always parallel with each other without crossing with each other as mentioned above, the azimuth of directivity of the group that has the greatest accumulated value of the reception level is determined as being the azimuth from which the signal is transmitted.

A second aspect of the invention relates to a tire information monitoring apparatus that monitors state of each of tires of a vehicle by transmitting information detected about each of the tire intermittently from a corresponding one of transmitters that are provided individually for the tires, and receiving the information by an antenna that is attached to the vehicle. The tire information monitoring apparatus has: directivity control means for controlling an azimuth of directivity of the antenna so that changing of the azimuth of directivity, in which the azimuth of directivity that achieves a maximum gain of the antenna is switched to an azimuth of a position of each of the tire, is performed repeatedly for a plurality of cycles during a transmission duration of the information; sampling means for sampling a value received by the antenna that is controlled by the directivity control means, separately for each of the azimuths of directivity that is switched to the azimuth of the position of each of the tire; number-of-incidents-of-largest-value count means for determining the azimuth of directivity that has, among the azimuths of directivity, a largest value that is sampled by the sampling means in the each cycle of the changing of the azimuth of directivity, and for counting a number of incidents of having the largest value separately for each of the azimuth of directivity that is switched to the azimuth of the position of each of the tire; and azimuth determination means for determining the position of the tire shown by the azimuth of directivity whose number of incidents counted by the number-of-incidents-of-largest-value count means is the largest among the azimuths of directivity as being the position of the tire equipped with the transmitter that is transmitting the information.

In the second aspect, as in the first aspect, the changing of the azimuth of directivity includes both the method of discretely changing the azimuth of directivity, and the method of continuously changing the azimuth. In the second aspect, every one of the cycles of the directivity control performed during the transmission duration of a piece of information, the apparatus determines the azimuth that has the greatest reception level of received signal among, for example, four azimuths. Then, during the transmission duration of a piece of information, the number of incidents of having the greatest reception level is counted separately for each of the four azimuths. Of the four azimuths, the azimuth whose number of incidents of having the greatest reception level is specifically determined as being the azimuth of the position at which the tire that is transmitting the information is disposed.

In the first and second aspects of the invention, a number of the cycles of the changing of the azimuth of directivity during the transmission duration may be increased if rotation speed of the tires increases. In other words, the shorter the cycle, the more improved the accuracy in determining the position. In the foregoing aspects, the changing of the azimuth of directivity means that the foregoing time-dependent change characteristic curves of the reception level obtained in the individual azimuths of directivity are sequentially switched from one to another with elapse of time, every time the sampling is performed. Therefore, the shorter the cycle of determination of the largest value, the smaller the range of the switching among the four time-dependent change characteristic curve of the reception level can be made. As a result, when at every sampling cycle, delayed received signal level is sampled, the magnitude relation among the sampled values can be caused to agree with the vertical positional relation among the time-dependent change characteristic curves of the reception level for the individual azimuths of directivity. Therefore, the azimuth of directivity that gives the largest value in this transmission duration gives the position of the tire that is transmitting the signal. Hence, the azimuth of directivity that has the largest number of incidents of having the largest value during the transmission duration of a piece of information is determined as being the azimuth of the position of the tire that is transmitting the signal.

Incidentally, in the foregoing description, the transmission duration in which the largest value is determined is renewed for every one cycle of the changing of the azimuth of directivity. However, it is to be noted herein that, for example, the renewing of the interval for every two cycles of the changing of the azimuth of directivity is equivalent to the elongation of the cycle of the changing to two times. Therefore, determining the largest value in every n number of cycles is equivalent to determining the largest value in every one elongated cycle that is n times as long as the foregoing cycle. Hence, the foregoing aspects of the invention include determining the largest value in every n number of cycles. Besides, in the first and second aspects, a number of the cycles of the changing of the azimuth of directivity during the transmission duration may be greater than or equal to 20. If the number of the cycles is greater than or equal to 20, it becomes easy to distinguish between the values of the reception level obtained when the azimuth of directivity is switched to the tire that is transmitting the information and the values of the reception level otherwise obtained. Besides, the inversion of the relation between the reception level of signal and the azimuth of directivity occurs when the tires are rotating, and is dependent on the rotation speed thereof. Therefore, the number of the cycles of the changing of the azimuth of directivity during the transmission duration may be increased with increases in the rotation speed of the tires.

In the foregoing aspects of the invention, the transmission duration may be 15 milliseconds.

In the foregoing aspects, even if the tires are rotating, the changing of the azimuth of directivity of the antenna is performed repeatedly for a plurality of cycles during the transmission duration of a piece of information, and the level of the signal received when the azimuth of directivity is directed to the position of any one of the tires is sampled. Then, during the transmission duration, the reception level is accumulated separately for each directivity. Besides, separately for each of the azimuths of directivity, the number of incidents of having the greatest reception level is counted in every cycle of the directivity switching control during the transmission duration of a piece of information. Then, the azimuth of directivity whose number of incidents of having the greatest reception level is the largest among the azimuths of directivity is determined as being the azimuth of the tire that is transmitting the information. Hence, since the azimuth of the tire is determined on the basis of the value obtained by averaging the signal levels during the transmission duration of a piece of information, false azimuth determination can be prevented despite rotation of the tires.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is an arrangement diagram of an apparatus of a first embodiment of the invention;

FIG. 2 is a construction diagram of a transmitter in the first embodiment;

FIG. 3 is a construction diagram of a receiver in the first embodiment;

FIG. 4 is an illustrative diagram showing a relation between an arrangement of the apparatus of the first embodiment and the azimuth of directivity of an antenna;

FIG. 5 is an illustrative diagram showing an azimuth-of-directivity switching control of the apparatus of the first embodiment;

FIG. 6A is a characteristic diagram showing changes of RSSI relative to the rotation angle of a tire;

FIG. 6B is a diagram showing an example of the mounting position of a transmitter unit on the tire;

FIG. 6C shows an example of time-dependent change characteristic of the RSSI;

FIG. 7 is a characteristic diagram showing time-dependent changes in the RSSI in the case where the directivity of the antenna is changed, for illustrating operations of the first embodiment and a second embodiment of the invention;

FIG. 8 is an illustrative diagram showing how the RSSI is sampled with various directivities in the apparatus of the first embodiment;

FIG. 9 is a characteristic diagram obtained by simulating a relation between the number of times of switching the azimuth of directivity per duration of transmission of information in the first embodiment and accumulated values of sampled values of the RSSI separately for each of the azimuths of directivity;

FIG. 10 is an illustrative diagram showing differences in the accumulated values of sampled values of the RSSI separately for the azimuths of directivity in the case where the number of times of changing the directivity per duration of transmission of information in the first embodiment;

FIG. 11 is a flowchart showing a processing procedure performed by a CPU in the case where the apparatus of the first embodiment is constructed by a computer system;

FIG. 12 is a flowchart showing a processing procedure performed by a CPU in the case where an apparatus of the second embodiment of the invention is constructed by a computer system; and

FIG. 13 is a characteristic diagram obtained by simulating a relation between the number of times of switching the azimuth of directivity per duration of transmission of information in the apparatus of the second embodiment and the accumulated numbers of incidents counted separately for each of the azimuths of directivity in which a corresponding one of the azimuths of directivity has the largest sampled value in one of control cycles.

### DETAILED DESCRIPTION OF EMBODIMENTS

Concrete embodiments of the invention will be described hereinafter with reference to the drawings. However, the invention is not limited to the embodiments described below.

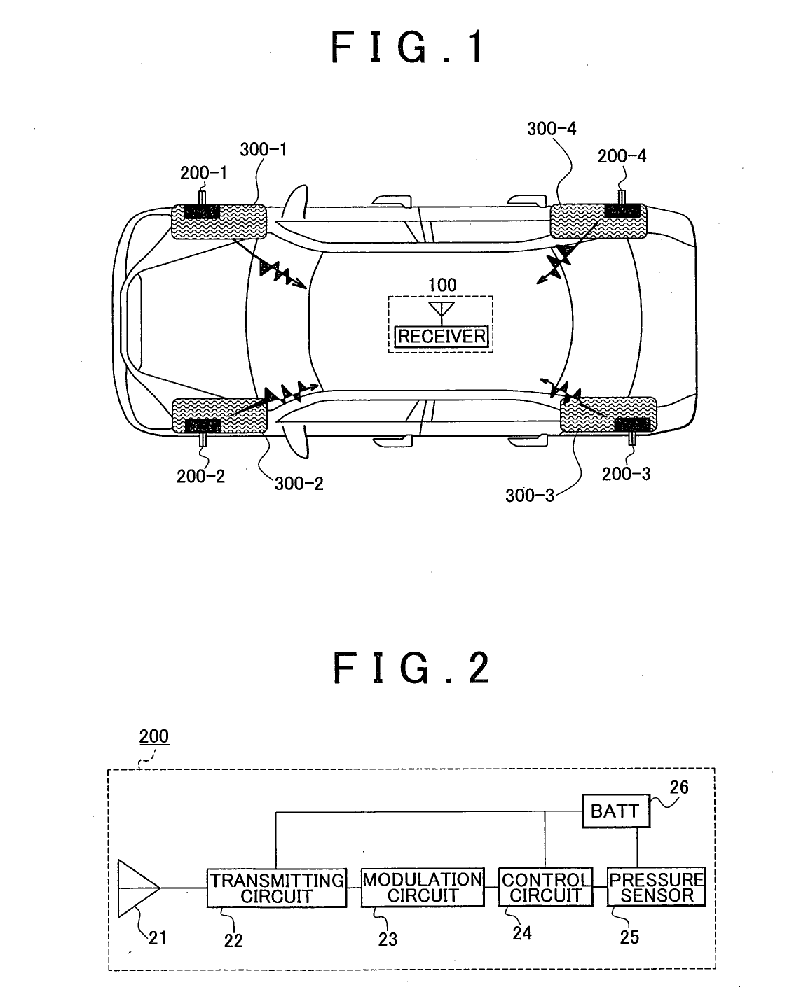

A tire air pressure monitoring system (tire information monitoring apparatus) of a first embodiment, as shown in FIG. 1, includes transmitters 200-1 to 200-4 (hereinafter, collectively termed the transmitters 200, when there is no need to distinguish each unit) that are provided for tires 300-1 to 300-4 (hereinafter, collectively termed the tires 300 when there is no need to distinguish each tire), respectively, and a receiver unit 100 that is provided on the vehicle body. Each tire 300 is provided with a transmitter unit 200. Each of the transmitter units 200 is fixed to a tire interior (e.g. the wheel) of a corresponding one of the tires, and rotates integrally with the corresponding tire. Besides, the receiver unit 100 is disposed near a center of a ceiling portion of a vehicle body.

As shown in FIG. 2, each transmitter unit 200 includes a control circuit 24 that performs various controls. A pressure sensor 25 that outputs a signal that corresponds to the tire air pressure of the corresponding tire 300 is connected to the control circuit 24. The output signal of the sensor 25 is input to the control circuit 24. On the basis of the output of the sensor 25, the tire air pressure of the corresponding tire 300 is detected. In this case, the control circuit 24 generates a transmission signal that includes information that shows the detected air pressure, and information that shows a unique identification code ID for identifying the host transmitter unit 200 from the other transmitter units 200, and outputs the generated transmission signal to the modulation circuit 23. The modulation circuit 23 modulates the signals, and outputs the modulated signal to a transmitting circuit 22. The transmitting circuit 22 superimposes the modulated wave on a carrier wave that has a predetermined frequency (e.g., in an RF band of several hundred MHz), and outputs the thus-formed waves to the transmitting antenna 21, which in turn sends out the signal.

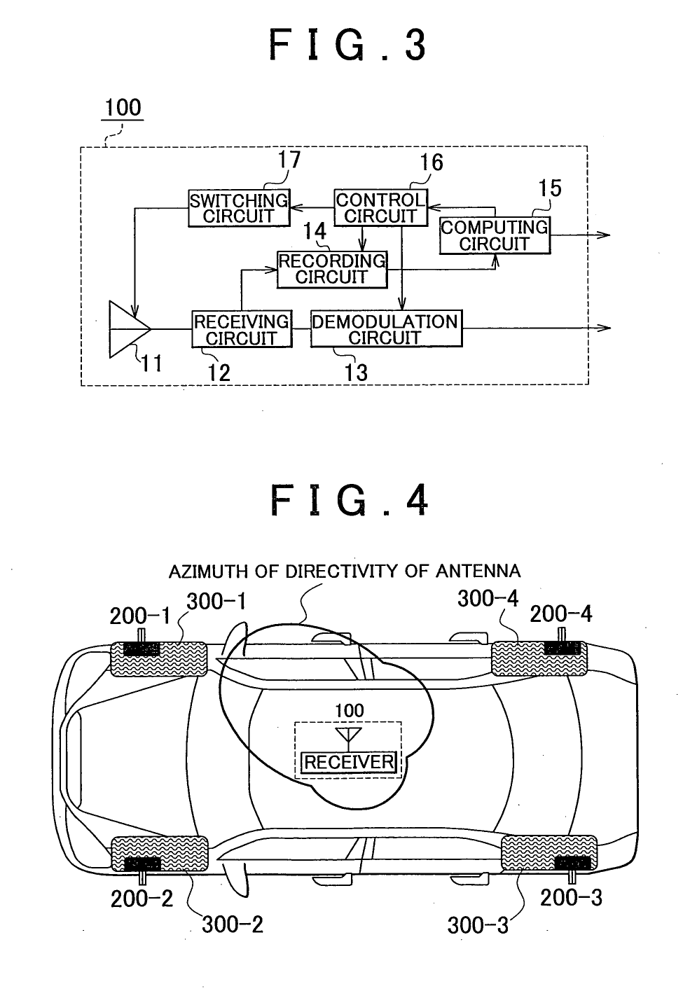

As shown in FIG. 3, the receiver unit 100 has: a receiving antenna 11 whose directivity is controllable; a receiving circuit 12 that performs the frequency conversion into a base band; a demodulation circuit 13 that demodulates the base-band signal; a control circuit 16 (directivity control means) that performs various controls; a switching circuit 17 (directivity control means) that switches the directivity of an antenna through the control performed by the control circuit 16; a recording circuit 14 (sampling means) that samples the output level of the receiving circuit 12, and that records the sampled values; and a computing circuit 15 (accumulation means, number-of-incidents-of-largest-value count means, and azimuth determination means) that determines the azimuth from which the reception signal has arrived on the basis of the sampled values. The demodulation circuit 13 demodulates the signal under the control of the control circuit 16, reconstructs the information regarding each tire and information regarding the unique identification code ID of the tire, and displays the information in a display portion (not shown). On the other hand, the level of the received signal strength indication (RSSI) detected by the receiving circuit 12 is sampled by the recording circuit 14 at timing designated by the control circuit 16, and is sequentially recorded. The computing circuit 15 performs computation on the basis of a pre-set computation procedure, and then specifically determines the direction of the transmission wave that is sent from the transmitter unit 200 on the basis of a result of the computation.

In the tire air pressure monitoring system of this embodiment, each transmitter unit 200 inputs the output signal of the pressure sensor 25, and detects the tire air pressure of the host tire 300 at intervals of a predetermined time (e.g., 1 minute, or the like) that is set beforehand. Then, after the detection is completed, the system generates a transmission signal that includes information about the air pressure and the information that shows the unique identification code ID of the host tire, superimposes the transmission signal on a predetermined electromagnetic carrier wave, and then transmits it from the transmitting antenna 21 to outside the transmitter unit 200. The time intervals at which the transmitter units 200 detect the tire air pressure and transmit the transmission signals may be equal to each other as long as the transmission timings are deviated from one transmission unit 200 to another. The transmission time interval may be randomly changed within a predetermined time width in each transmitter unit 200 so that transmission signals from different transmitter units 20 will not collide with each other.

On the other hand, in the receiver unit 100, as shown in FIG. 4, the receiving antenna 11 is constructed so that the azimuth of directivity of the receiving antenna 11 is changed so that a maximum gain is obtained in each of the azimuths of the mounted positions of the tires 300, that is, the tire FR (front right wheel) 300-1, the tire FL (front left wheel) 300-2, the tire RL (rear left wheel) 300-1, and the tire RR (rear right wheel) 300-4. Concretely, the receiver unit 100 determines the order of the azimuths of the mounted positions of the tires 300 for obtaining the maximum gain, and sequentially changes the azimuth of directivity of the receiving antenna 11 according to the sequence of the azimuths. For example, the receiver unit 100 changes the azimuth of directivity of maximum gain of the receiving antenna 11 in the following order of the azimuths of the mounted positions of the tires 300, that is, in the order of the tire FR 300-1, the tire FL 300-2, the tire RL 300-3 and the tire RR 300-4. The directivity of the receiving antenna 11 is sequentially switched by the switching circuit 17 that is controlled by the control circuit 16.

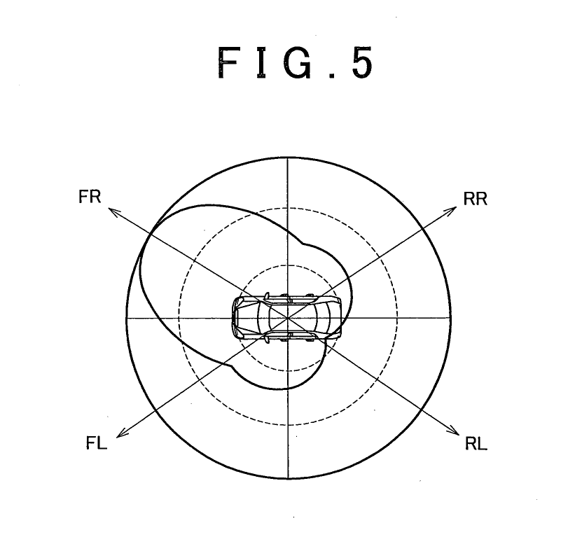

Next, a tire-mounted position identification technique will be described. FIG. 5 shows a directivity pattern obtained when the azimuth of directivity that achieves the maximum gain of the receiving antenna 11 used in the invention is set to the azimuth of the tire FR 300-1. Although this diagram shows only the directivity pattern in the case of the tire FR 300-1, the directivity pattern is substantially the same for the cases of the tire FL 300-2, the tire RL 300-3 and the tire RR 300-4 while only the azimuths of directivity of the main beam for the tires are different.

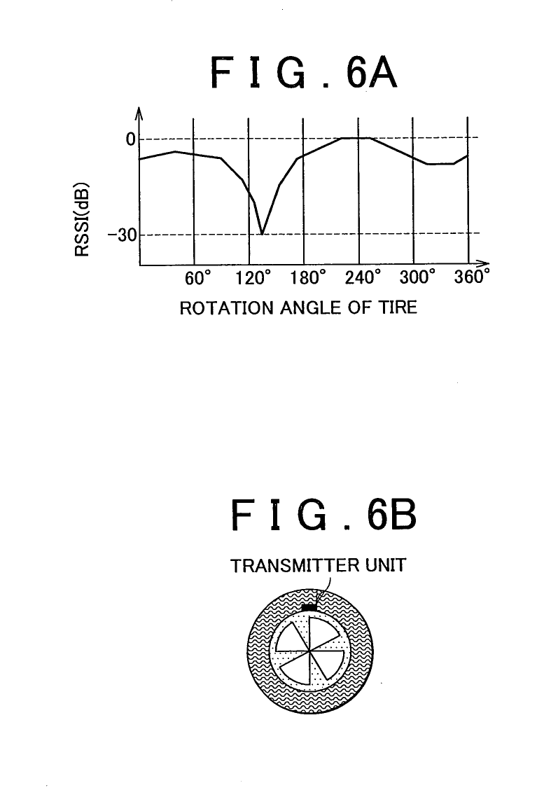

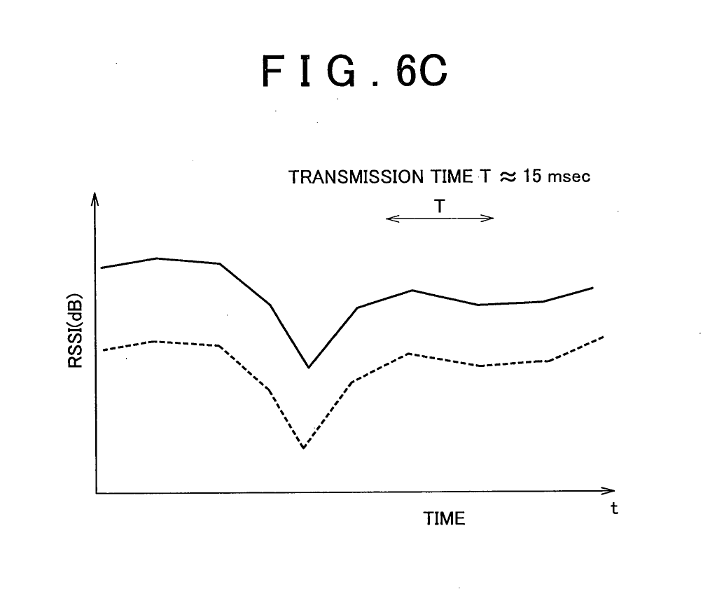

FIG. 6A shows an example of the RSSI (in the unit of dB) obtained when a tire 300 is rotated. The position of attachment of a transmitter unit 200 to the tire 300 is shown in FIG. 6B. FIG. 6C shows an example of a time-dependent change characteristic of the RSSI (in the unit of dB) when the vehicle is traveling at a speed of 100 km per hour, in the case where the transmission time T for the transmission of one piece of information from the Besides is T≈15 msec. In this diagram, a solid line shows a time-dependent change characteristic of the RSSI obtained in the case where the directivity of the antenna 11 that achieves the maximum gain is set to the mounted position of a tire 300 to which a signal is transmitted, and an interrupted line shows a time-dependent change characteristic of the RSSI obtained in the case where the directivity of the antenna 11 is set to the azimuth that is opposite (180°) to the azimuth of the mounted position of the tire 300 to which a signal is transmitted. It can be seen that fluctuations of 20 dB or greater exist within the transmission time T in both the case.

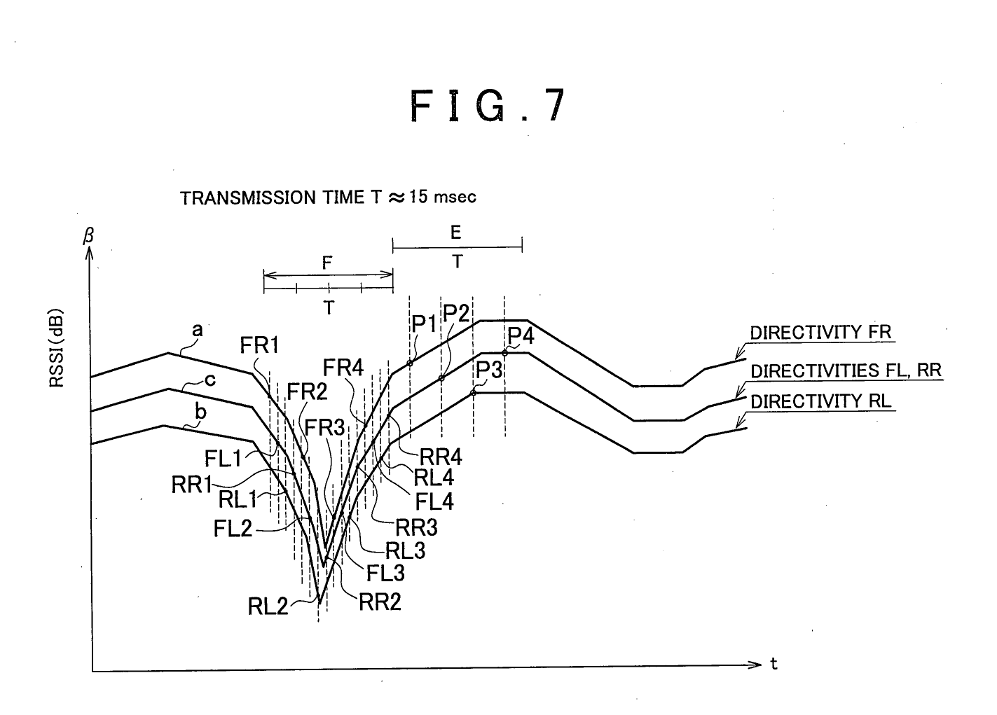

In the case where the tire FR 300-1 is transmitting signals, the relation between the RSSI and the directivity becomes as follows. That is, the relation of b<c<a is established, where “a” is the sensitivity in the case where the directivity of the antenna 11 which achieves the maximum gain thereof is controlled to the azimuth of the tire FR 300-1, and “b” is the sensitivity in the case azimuth of directivity is controlled to the azimuth of the tire RL 300-3 that is opposite, that is, 180°, to the azimuth of the tire FR 300-1, and “c” is the sensitivity in the case where the directivity of the antenna 11 which achieves the maximum gain thereof is controlled to the azimuths of the tire FL 300-2 and the tire RR 300-4 that are assumed to be equal to each other. Therefore, the RSSI of the signal from the tire FR 300-1 is as shown in FIG. 7 when the directivity of the antenna 1 that achieves the maximum gain of the antenna 11 changes in the order of the azimuth of the tire FR 300-1, the azimuth of the tire FL 300-2, the azimuth of the tire RL 300-3, and the azimuth of the tire RR 300-4.

In an interval E of the transmission duration T of a piece of information, the RSSI of the signal from the tire FR 300-1 assumes the values shown at the points P1, P2, P3 and P4 in FIG. 7 if the azimuth of directivity that achieves the maximum gain of the antenna 11 sequentially changes in the order of the azimuths of the tire FR 300-1, the tire FL 300-2, the tire RL 300-3 and the tire RR 300-4. In this embodiment, since the level at the point P1<the level at the point P4, the maximum RSSI is the reception level P4 that is received when the directivity is in the azimuth of the tire RR 300-4. That is, when the azimuth of the tire 300 is to be determined on the basis of the maximum RSSI, it is sometimes falsely determined that the tire 300 that is transmitting the signal is the tire RR 300-4 although it is actually the tire FR 300-1. The probability of such false determination becomes higher the greater the rotation speed of the tire 300 is, because the greater the rotation speed thereof, the greater the temporal differentiation of the RSSI.

Next, as shown in an interval F in FIG. 7, during the transmission duration T of a piece of information, if one cycle of the change in the directivity during which the maximum gain of the antenna 11 is obtained is shortened to T/4, one cycle of the directivity control is repeatedly performed 4 times, that is, four cycles of the control are performed. Then, in every interval of time T/4, the level of the signal received in the four azimuths of directivity of the antenna 11 that achieve the maximum gain is sequentially sampled, and are grouped for each of the azimuths of directivity. The RSSI, as shown in FIG. 7, changes in the order of the points FR1, FL1, RL1, RR1, FR2, FL2, RL2, RR2, FR4, FL4, RL4, RR4. Then, the sampled values of the group of points FR are the values at the points FR1, FR2, . . . , FR4, and the sampled values of the group of points FL are the values at the points FL1, FL2, FL4, and the sampled values of the group of points RL are the values at the points RL1, RL2, RL4, and the sampled values of the group of points RR are the values at the points RR1, RR2, RR4. These sampled values obtained in each of the directivity azimuth accurately trace the time-dependent fluctuation characteristic curve of the RSSI that is received in that azimuth of directivity. Therefore, if such sampled values are accumulated during the transmission duration T of a piece of information, the azimuth of directivity indicated by the group that has the largest accumulated value is the azimuth of the tire 300 to be found. In this case, since the set of sampling points in each azimuth of directivity accurately traces a corresponding one of the time-dependent change characteristic curves of the RSSI, the azimuth of directivity that achieves the largest average value of the RSSI can be accurately determined as being the azimuth of the tire 300 that is transmitting the signal.

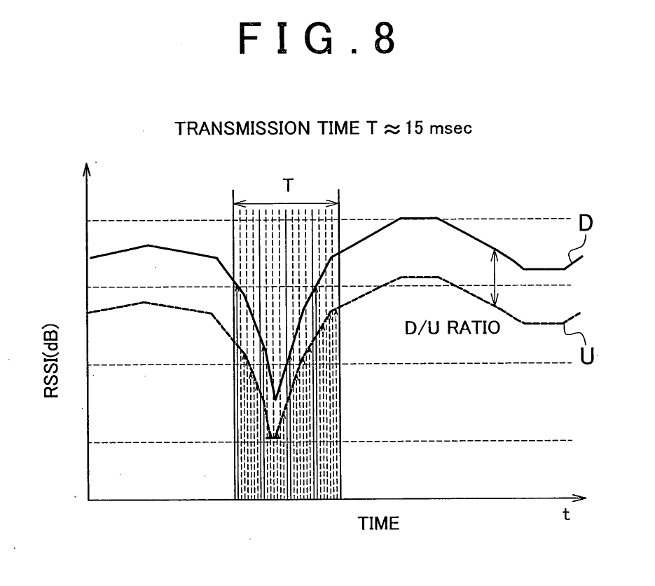

FIG. 8 shows the sampling timing during the transmission duration T in the control of switching the directivity of the antenna 11 that achieves the maximum gain thereof. However, the characteristic obtained when the directivity of the antenna 11 that achieves the maximum gain is switched to the azimuth of any one of the tire FL 300-2, the tire RR 300-3 and the tire RL 300-4 that are not transmitting signals is shown by a interrupted line U. The directivity of the antenna 11 is sequentially scanned, that is, varied, at time intervals that are shorter than the transmission duration T. Then, using the computing circuit, the values of RSSI (in the unit of dB) are accumulated for each of the azimuths of directivity of the antenna 11 in which the maximum gain is achievable, the accumulated values are compared, and the azimuth of directivity that actually achieves the highest level of the accumulated value is identified as being the azimuth of the position at which the transmitter 200 is disposed.

In FIG. 8, the change characteristics of RSSI are shown only by two lines, that is, a solid line D for the case where the azimuth of directivity of the antenna 11 that achieves the maximum gain thereof coincides with the azimuth of the tire 300 that is transmitting the signal, and the interrupted line U for the case where the azimuth of directivity of the antenna 11 that achieves the maximum gain thereof does not coincide with the azimuth of the tire 300 that is transmitting the signal. The three azimuths of directivity of the antenna 11 that achieve the maximum gain but that do not coincide with the azimuth of the tire 300 that is transmitting the signal are assumed to provide equal sensitivities. Precisely, characteristics as shown in FIG. 7 are obtained. In the transmission duration T during which the transmitter 200-1 provided for the tire FR 300-1 is transmitting the signal, the control of switching the azimuth of directivity of the antenna 11 that achieves the maximum gain thereof in the order of the azimuths of the tire FR 300-1, the tire FL 300-2, the tire RL 300-3 an tire RR 300-4 is regarded as a single cycle. FIG. 7 shows a time-dependent change characteristic of the RSSI in the case where the control is performed for four cycles.

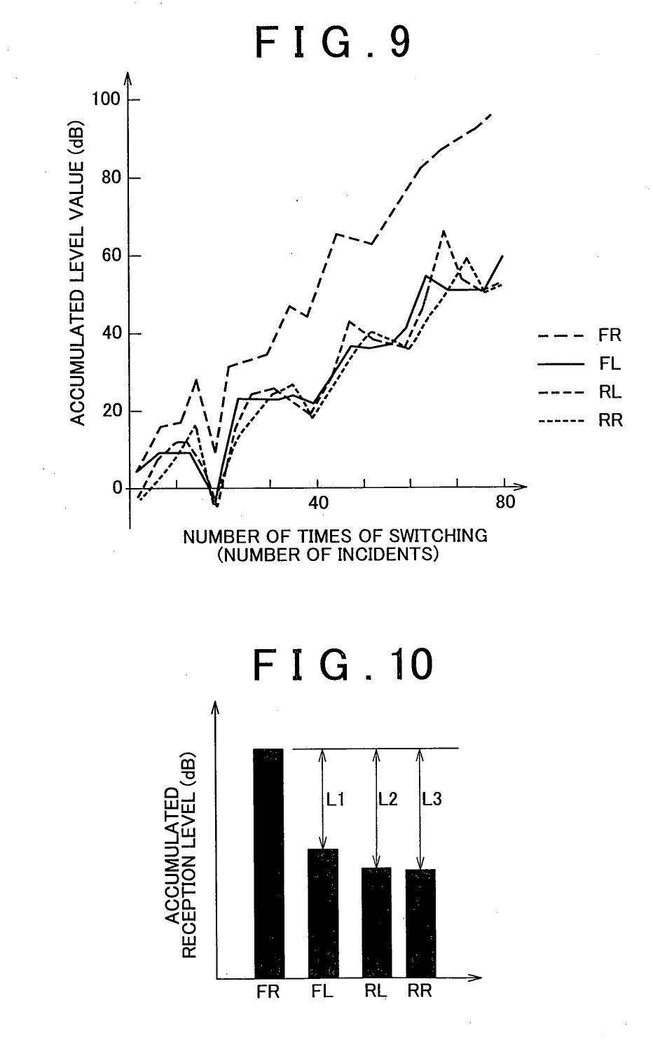

FIG. 9 shows a relation between the number of times of switching the azimuth of directivity of the antenna 11 that achieves the maximum gain thereof during the transmission duration T of a piece of information and the accumulated values of sampled values of the RSSI separately for the individual azimuths of directivity. In FIG. 9, four consecutive points of sampling correspond to one cycle of the control of switching the directivity of the antenna 11 that achieves the maximum gain thereof. Therefore, 80 sampling points correspond to 20 cycles of the directivity switching control. At about 20 cycles, the difference between the accumulated values for the different azimuths of directivity decreases. However, after that, the difference between the accumulated values increases to a size that is sufficiently large to specifically determine the azimuth of the position at which the transmitter 200 is disposed. FIG. 10 shows the accumulated values of sampled values obtained in the individual azimuths of directivity of the antenna 11 in the case where the cycle of sequentially switching the azimuth of directivity of the antenna 11 to each of the azimuths of directivity of the positions of the transmitters 200 is performed 100 times. In this embodiment, there is a difference of about 40 dB between the accumulated value obtained in the case where the azimuth of directivity is switched to the azimuth from which the signal is transmitted and the accumulated values obtained in the cases where the azimuth of directivity is switched to an azimuth from which the signal is not transmitted (shown in FIG. 9). The size of difference between the accumulated values makes it possible to accurately determine the azimuth of the position of the transmitter 200 that is transmitting the signal. The number of times of performing the switching of the azimuth of directivity of the antenna 11 that achieves the maximum gain thereof, that is, the number of times of performing the accumulation, can be arbitrarily set, and can be suitably set by taking into consideration various requirements of the tire air pressure monitoring system regarding the azimuth discernment accuracy, the cost of a device for performing the sampling, etc.

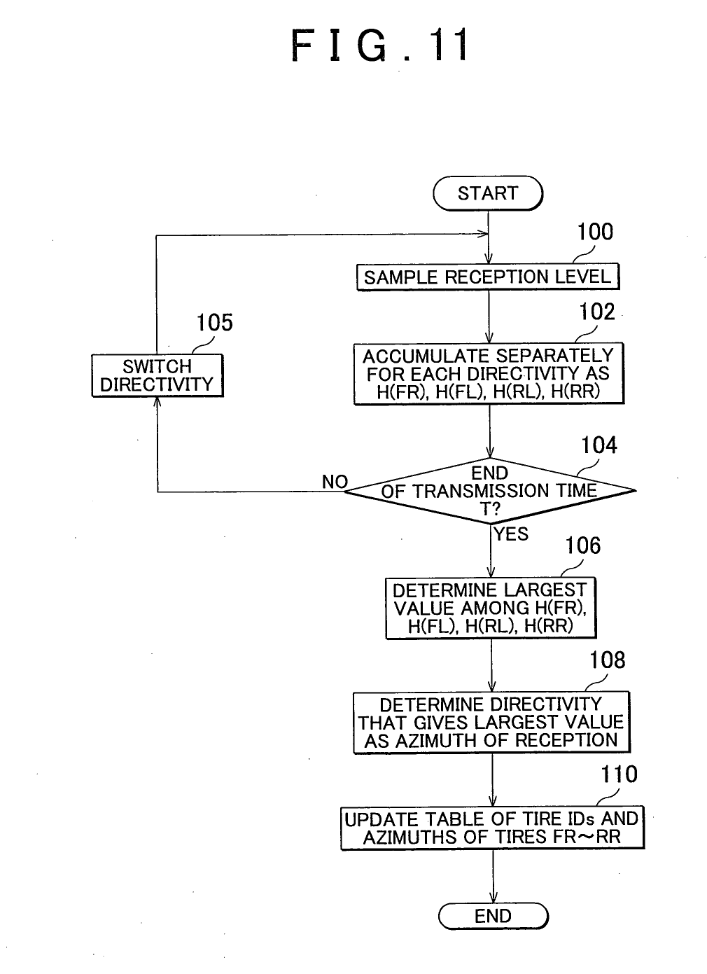

The control circuit 16 and the computing circuit 15 that constitute the receiver unit 100 of this embodiment are constructed of a CPU, and the like. A processing procedure of the CPU is shown in FIG. 11. Incidentally, the processing procedure shown in FIG. 11 may be always executed, or may also be activated when a signal of a predetermined level or higher is received. Specifically, the processing procedure may be activated at the timing at which any one of the tires 300 outputs a signal.

In step 100, the CPU assumes that the antenna 11 faces one of the azimuths of the four tires 300, and performs the sampling of the RSSI. Next in step 102, the CPU accumulates the sampled values separately for the individual azimuths of directivity as the accumulated values H(FR), H(FL), H(RL) and H(RR). Next in step 104, the CPU determines whether or not the transmission duration T has ended. If the transmission duration T has not ended (NO in step 104), the process proceeds to step 105, in which the CPU controls the switching circuit 17 so as to shift the azimuth of directivity to the next azimuth of the tire 300. After step 105, the process returns to step 100. Thus, the loop of steps 100 to 105 is repeatedly performed until it is determined in step 104 that the transmission duration T has ended. If in step 104 it is determined that the transmission duration T has ended, the process proceeds to step 106, in which the CPU determines the largest value among the accumulated values H(FR), H(FL), H(RL) and H(RR). Then, the CPU specifically determines the azimuth of directivity of the antenna 11 in which the accumulated value H is the largest of all, as the azimuth of the tire 300 that is transmitting a signal. Besides, each tire 300 is constructed so as to transmit its tire ID. Therefore, in the next step 110, the CPU updates a table in which a relation between the tire IDs and the positions of the tires 300 is stored. Since the table is updated in this manner, the position of the tire 300 can be specifically determined by the tire ID from that time on. Therefore, it becomes possible to easily identify an abnormal tire.

In the case where the tire IDs are used, the CPU may update the table that prescribes such a relation between the tire IDs and the positions of the tires 300 at arbitrary update timing. Besides, this tire air pressure monitoring system is able to detect the azimuths of transmission of signals from the tires 300 all the time, that is, even when the vehicle is running. Therefore, the system is able to identify a tire 300 that is transmitting a signal, without a need to use the tire ID.

An apparatus construction of a tire air pressure monitoring system in accordance with a second embodiment of the invention is the same as that of the first embodiment. Therefore, the same component elements as those in the foregoing embodiment will not be described again below. Referring back to FIG. 7, operation of the second embodiment will be described. In FIG. 7, in every one of the durations T/4 in the interval F, a largest value of the four sampled values is determined. Then, the number of incidents of having the largest value is accumulated or counted during the transmission duration T of a piece of information for each of the azimuths of directivity of the antenna 11 that achieves the maximum gain thereof. When the transmission duration T ends, the azimuth of directivity that has a largest count of the number of incidents of having the largest value is specifically determined as the azimuth of transmission of a signal.

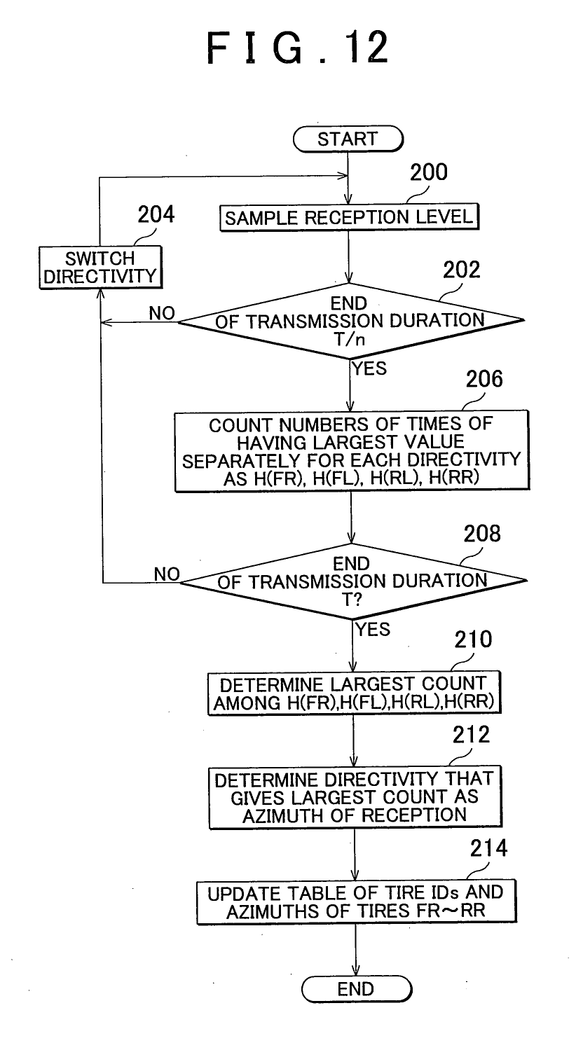

A process performed by a CPU that constitutes a receiver unit 100 is shown in FIG. 12. The CPU samples the received signals in step 200. Until it is determined in step 202 that the duration of T/n ends, the CPU repeatedly performs the process of steps 200 to 204 to store sampled values separately for each of the azimuths of directivity of the antenna 11 that achieve the maximum gain thereof. It is to be noted herein that n in the foregoing duration of T/n is an integer, and T/n is the time of one cycle of the directivity switching control. If in step 202 it is determined that one cycle T/n of the directivity switching control has ended, the process proceeds to step 206, in which the azimuth of directivity of the antenna 11 that achieves the maximum gain thereof having the largest value in that cycle T/n is determined. Then, the number of incidents of having the largest value is stored separately for each of the azimuths of directivity, as the accumulated number of incidents H(FR), H(FL), H(RL) and H(RR).

Next, in step 208, the CPU determines whether or not the transmission duration T has elapsed. If the transmission duration T has not elapsed, the process returns to step 204, to repeat the foregoing process. Then, the accumulated number of incidents of having the largest value is accumulated separately for each directivity in step 206. If in step 208 it is determined that the transmission duration T has elapsed, the CPU determines in step 210 the largest count among the accumulated number of incidents H(FR), H(FL), H(RL) and H(RR). Then, in step 212, the azimuth of directivity of the antenna 11 that achieves the maximum gain thereof having the largest count is specifically determined as the azimuth in which the signal is being transmitted. Besides, each tire 300 is constructed so as to transmit its tire ID. Therefore, in step 214, the CPU updates a table in which a relation between the tire IDs and the positions of the tires 300 is stored. Since the table is updated in this manner, the positions of the tires 300 can be specifically determined by the tire IDs from that time on. Therefore, it becomes possible to easily identify an abnormal tire.

In this embodiment, if the cycle T/n becomes long relative to the rotation speed of the tires 300, there is an increased probability that the azimuth of directivity of the antenna 11 that achieves the maximum gain thereof and that has the largest RSSI does not coincide with the azimuth of the tire 300 that is transmitting the signal. Specifically, if the amount of change of the RSSI per unit time becomes large, the relation between the RSSI and the azimuth of directivity is inverted as stated above. Therefore, it is desirable to make the cycle T/n of the directivity switching control shorter the faster the rotation speed of the tires 300, or to make the number n in T/n greater the greater the rotation speed of the tires 300.

In this embodiment, too, in the case where the tire IDs are used, the CPU may update the table that prescribes the aforementioned relation between the tire IDs and the positions of the tires 300 at arbitrary update timing. Besides, this tire air pressure monitoring system is able to detect the azimuths of transmission of signals from the tires 300 all the time, that is, even when the vehicle is running. Therefore, the system is able to determine a tire 300 that is transmitting a signal, without a need to use the tire ID.

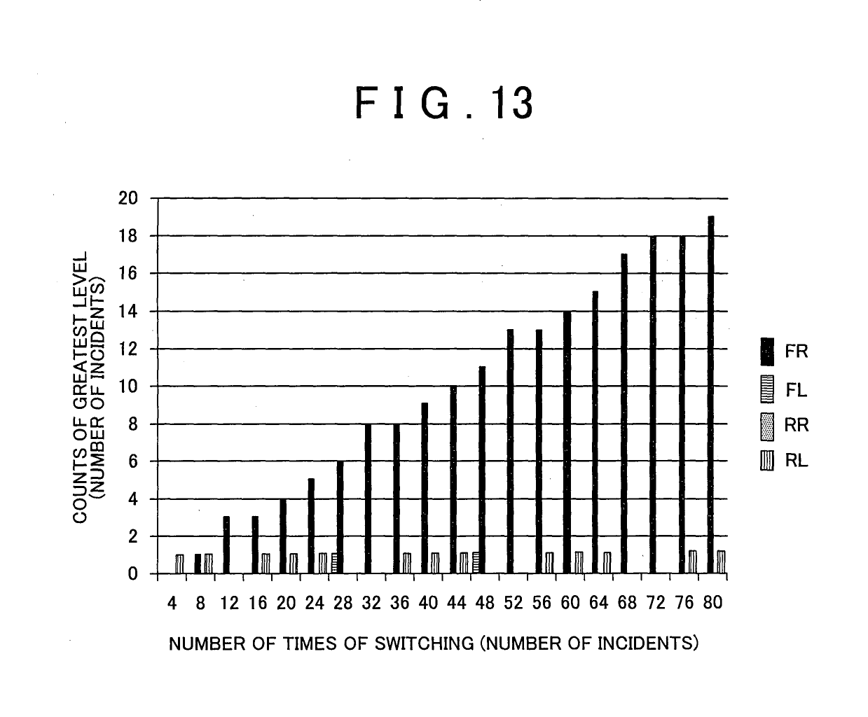

FIG. 13 shows a relation between the number of times of switching the directivity of the antenna 11 that achieves the maximum gain thereof during the transmission duration T of a piece of information and the accumulated numbers of incidents counted separately for each of the azimuths of directivity in which a corresponding one of the azimuths of directivity has the largest value in one of the foregoing control cycle. Four consecutive points of sampling correspond to one cycle of the control of switching the directivity of the antenna 11 that achieves the maximum gain thereof. Therefore, 80 sampling points correspond to 20 cycles of the directivity switching control. When the number of cycles is equal to or greater than 20, the difference between the accumulated numbers of incidents in the different azimuths of directivity increases to a size that is sufficiently large to specifically determine the azimuth of the position of the transmitter 200 that is transmitting a signal.

Although the construction of the antenna 11 whose directivity is switched is not described in detail herein, it is possible to use, for example, a directivity switchable antenna described in Japanese Patent Application Publication No. 2001-24431 (JP-A-2001-24431).

Although in the foregoing embodiments, the tire air pressure monitoring system receives tire information from all the tires 300, it is also permissible to adopt a construction in which the tire information of only arbitrary tires determined beforehand is received.

While the invention has been described with reference to example embodiments thereof, it is to be understood that the invention is not limited to the described embodiments or constructions. To the contrary, the invention is intended to cover various modifications and equivalent arrangements. In addition, while the various elements of the disclosed invention are shown in various example combinations and configurations, other combinations and configurations, including more, less or only a single element, are also within the scope of the appended claims.

1-10. (canceled)

11. The tire information monitoring apparatus according to claim 17, wherein a number of the cycles of the changing of the azimuth of directivity during the transmission duration is greater than or equal to 20.

12. The tire information monitoring apparatus according to claim 17, wherein a number of the cycles of the changing of the azimuth of directivity during the transmission duration is increased as rotation speed of the tires increases.

13. The tire information monitoring apparatus according to claim 17, wherein the transmission duration is 15 milliseconds.

14. The tire information monitoring apparatus according to claim 18, wherein a number of the cycles of the changing of the azimuth of directivity during the transmission duration is greater than or equal to 20.

15. The tire information monitoring apparatus according to claim 18, wherein a number of the cycles of the changing of the azimuth of directivity during the transmission duration is increased as rotation speed of the tires increases.

16. The tire information monitoring apparatus according to claim 18, wherein the transmission duration is 15 milliseconds.

17. A tire information monitoring apparatus that monitors state of each of tires, comprising:
transmitters which are provided individually for the tires of a vehicle and each of which intermittently transmits information detected about a corresponding one of the tires,
an antenna that is attached to the vehicle and that receives the information transmitted by the transmitters;
a directivity control device that controls an azimuth of directivity of the antenna so that changing of the azimuth of directivity, in which the azimuth of directivity that achieves a maximum gain of the antenna is switched to an azimuth of a position of each of the tire, is performed repeatedly for a plurality of cycles during a transmission duration of the information;
a sampling device that samples a value received by the antenna that is controlled by the directivity control device, separately for each of the azimuths of directivity that is switched to the azimuth of the position of each of the tire;
an accumulation device that sorts the values sampled by the sampling device into groups separately for each of the azimuth of directivity that is switched to the azimuth of the position of each of the tire, and accumulating the values separately for each of the group;
an azimuth determination device that determines the position of the tire shown by the azimuth of directivity of the group whose value accumulated by the accumulation device is the largest of the values of the groups accumulated by the accumulation device as being the position of the tire equipped with the transmitter that is transmitting the information.

18. A tire information monitoring apparatus that monitors state of each of tires, comprising:
transmitters which are provided individually for the tires of a vehicle and each of which intermittently transmits information detected about a corresponding one of the tires,
an antenna that is attached to the vehicle and that receives the information transmitted by the transmitters;
a directivity control device that controls an azimuth of directivity of the antenna so that changing of the azimuth of directivity, in which the azimuth of directivity that achieves a maximum gain of the antenna is switched to an azimuth of a position of each of the tire, is performed repeatedly for a plurality of cycles during a transmission duration of the information;
a sampling device that samples a value received by the antenna that is controlled by the directivity control device, separately for each of the azimuths of directivity that is switched to the azimuth of the position of each of the tire;
a number-of-incidents-of-largest-value count device which determines the azimuth of directivity that has, among the azimuths of directivity, a largest value that is sampled by the sampling means in the each cycle of the changing of the azimuth of directivity, and which counts a number of incidents of having the largest value separately for each of the azimuth of directivity that is switched to the azimuth of the position of each of the tire; and
an azimuth determination device that determines the position of the tire shown by the azimuth of directivity whose number of incidents counted by the number-of-incidents-of-largest-value count means is the largest among the azimuths of directivity as being the position of the tire equipped with the transmitter that is transmitting the information.
